(19) United States
(12) Patent Application Publication
(10) Pub. No.: US 2006/0197497 A1
(43) Pub. Date: Sep. 7, 2006

(54) Electric accessory

(76) Inventors: Kwan Butt Albert Wong, Hong Kong (CN); Ka King Ma, Hong Kong (CN)

Correspondence Address: SMITH-HILL AND BEDELL, P.C., 16100 NW CORNELL ROAD, SUITE 220, BEAVERTON, OR, 97006, US

(21) Appl. No.: 11/074,489

(22) Filed: Mar. 7, 2005

(51) Int. Cl. H02J 7/00

(52) U.S. Cl. 320/114

(57) ABSTRACT

An automatic electric charger connectable with a number of electric appliance for providing electric power to the appliances is disclosed as including an RF transceiver for receiving data representing charging and/or powering parameters of the appliances; an I/O unit electrically connected with an electric power source for receiving electric power therefrom, and electrically connectable with the appliances for transmitting electric power thereto; in which the I/O unit may vary, in accordance with the received data, the voltage of the electric power received from the electric power source for subsequent transmission to the appliances. A method of providing electric power to a number of electric appliances is disclosed as including the steps of (a) contactlessly receiving data representing charging and/or powering parameters of the appliances; (b) receiving electric power from an electric power source; (c) varying, in accordance with the received data, the voltage of the received electric power; and (d) transmitting the varied electric power to the appliances.

This invention relates to an electric accessory for providing electric power to an electric appliance, whether for powering the electric appliance or charging an electric battery in the electric appliance.

### BACKGROUND OF THE INVENTION

As personal mobile electronic appliances, e.g. mobile phones, personal digital assistants (PDA's), digital cameras, laptop computers and etc., are getting more and more popular these days, many people are experiencing the inconvenience of keeping an increasing number of battery chargers/AC adaptors/DC adaptors that come with each of the appliances, as provided by the manufacturers. This is also not environmental friendly since inappropriate deposal of used battery chargers will pollute our environment.

Many personal mobile electronic appliances available in the market come with a separate battery charger specifically designed for each model of product. One could easily have several battery chargers, including used ones, at home. Every time when one needs to re-charge the battery of an electronic appliance, he or she needs to manually select the right charger to serve the purpose, not to mention the pain of carrying various kinds of personal electronic appliances each with its own battery charger/AC adaptor/DC adaptor for out-of-town travels.

One problem with conventional battery chargers of variable charging outputs is that they require visual confirmation of the charging parameters labeled on the battery or the appliance as well as cumbersome manual switching procedures to vary the required charging output by users. This calls for a need of a single battery charger which can substitute many battery chargers of a wide range of charging parameters and a method to automatically vary the output of the said charger to the appropriate parameters that match those specified for the battery to be charged. Preferably, this charger can also serve as an AC/DC adaptor to provide electric power to electric appliances, irrespective of whether such appliances have battery or not.

It is thus an object of the present invention to provide an electric accessory in which the above shortcomings are mitigated, or at least to provide a useful alternative to the public.

It is a further object of the present invention to provide a method of providing electric power to at least one electric appliance.

### SUMMARY OF THE INVENTION

According to a first aspect of the present invention, there is provided an electric accessory adapted to be connected with at least one electric appliance for providing electric power to said appliance, said accessory including means adapted to contactlessly receive data representing at least one charging and/or powering parameter of said at least one appliance; transforming means adapted to be electrically connected with an electric power source for receiving electric power therefrom, and adapted to be electrically connected with said appliance for transmitting electric power thereto; wherein said transforming means is adapted to vary, in accordance with said received data, at least one parameter of the electric power received from said electric power source for subsequent transmission to said appliance.

According to a second aspect of the present invention, there is provided a method of providing electric power to at least one electric appliance, including the steps of (a) contactlessly receiving data representing at least one charging and/or powering parameter of said at least one appliance; (b) receiving electric power from an electric power source; (c) varying, in accordance with said received data, at least one parameter of the received electric power; and (d) transmitting the varied electric power to said at least one appliance.

### BRIEF DESCRIPTION OF THE DRAWINGS

A preferred embodiment of the present invention will now be described, by way of example only, with reference to the accompanying drawings, in which:

FIG. 1 is a functional block diagram of an automatic charger according to a preferred embodiment of the present invention;

FIG. 2 is a basic functional block diagram of an integrated circuit (IC) in the automatic charger shown in FIG. 1;

FIG. 3 is a further functional block diagram of the RF transceiver, IC and input/output unit of the automatic charger shown in FIG. 1;

FIG. 4 is a block diagram of an exemplary radio frequency multi-function reader module used in the automatic charger shown in FIG. 3;

FIG. 5A is a top view of an exemplary TIL-RS232 Interface used in the automatic charger shown in FIG. 3;

FIG. 5B is a typical circuit of the TIL-RS232 Interface shown in FIG. 5A;

FIG. 6 is a functional block diagram of an exemplary IC used in the automatic charger shown in FIG. 3;

FIG. 7A is a functional block diagram of a first exemplary DC-DC converter used in the automatic charger shown in FIG. 3;

FIG. 7B is a functional block diagram of a second exemplary DC-DC converter used in the automatic charger shown in FIG. 3;

FIG. 7C is a functional block diagram of a third exemplary DC-DC converter used in the automatic charger shown in FIG. 3;

FIG. 8 is a functional block diagram of an analogue-to-digital converter used in the automatic charger shown in FIG. 3;

FIG. 9 is a flow chart showing steps of operation of the automatic charger shown in FIG. 1;

FIG. 10 is a flow chart showing steps of operation of the adjustment module of the automatic charger shown in FIG. 1; and

FIG. 11 is a flow chart showing alternative steps of operation of the automatic charger shown in FIG. 1.

### DETAILED DESCRIPTION OF THE PREFERRED EMBODIMENT

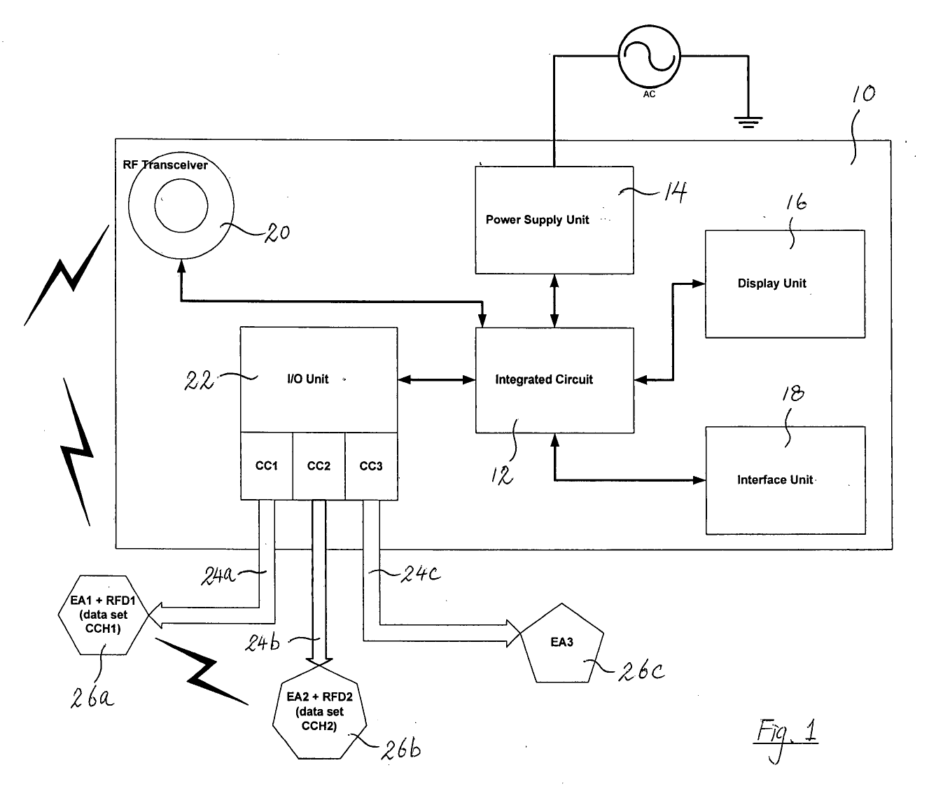

A functional block diagram of an automatic electric charger 10 according to a preferred embodiment of the present invention is shown in FIG. 1. It should be understood that the term “battery charger” is here used in its widest sense, namely a device for providing electric power to at least one electric appliance, to power the operation of the electric appliance and/or to charge a battery associated with the electric appliance.

The charger 10 includes an integrated circuit (IC) 12 for controlling and regulating its operation, and a power supply unit 14 for powering the operation of the charger 10. The power supply unit 14 may be a DC battery. Alternatively, as in the case now shown in FIG. 1, the power supply unit 14 may be a transformer connectable with a municipal source of AC electricity for transforming the AC into DC for powering the charger 10, and for subsequent transmission to electric appliances connected with the charger 10.

In addition to the power supply unit 14, the IC 12 is also connected with a display unit 16, e.g. an LCD, an interface unit 18, which may include a number of buttons allowing a user to manually operate the charger 10, a radio frequency (RF) transceiver 20, and an input/output (I/O) unit 22. Three charging cables 24a, 24b, 24c are electrically connected with the I/O unit 22 for physical and electrical connection with and providing electric power to a respective electric appliance 26a, 26b, 26c, each with a different set of charging/powering parameters. In the present invention, charging/powering parameters may include such characteristics as charging/powering voltage, battery voltage, current, cycle, charging algorithm, etc.

Each of the electric appliances 26a, 26b, 26c is attached with a radio frequency identification (RFID) tag embedded with a respective integrated circuit (IC) into which data representing the charging/powering parameters of the respective electric appliances 26a, 26b, or 26c, or of the battery in the appliance, are entered. Additional information which may be entered into the IC in the RFID tag includes the type of electric appliance (e.g. a mobile phone, or a laptop computer), the manufacturer, model number, and a unique identification (ID) code for differentiating electric appliances of the same model from the same manufacturer.

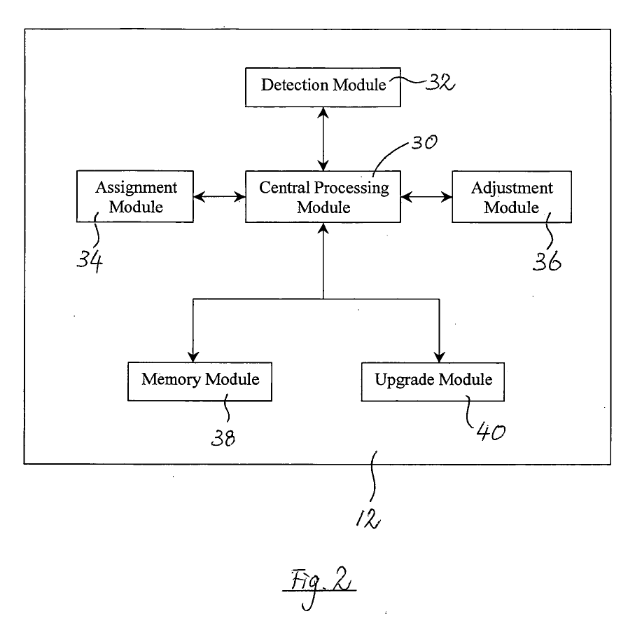

Turning to FIG. 2, such shows a basic functional block diagram of the IC 12 in the charger 10. The IC 12 includes:
a central processing module 30 with number processing capability, for providing instructions and supporting operations of other modules and units of the charger 10;
a detection module 32 for detecting, through the RF transceiver 20, RFIDs within its operating vicinity;
an assignment module 34 for assigning the detected electric appliances to respective charging channels;
an adjustment module 36 for adjusting the output characteristics of charging channels with reference to the detected charging characteristics;
a memory module 38 for storing various parameters in support of operations of other modules and units of the charger 10; and
an upgrade module 40 for supporting the upgrade of various modules and units of the charger 10.

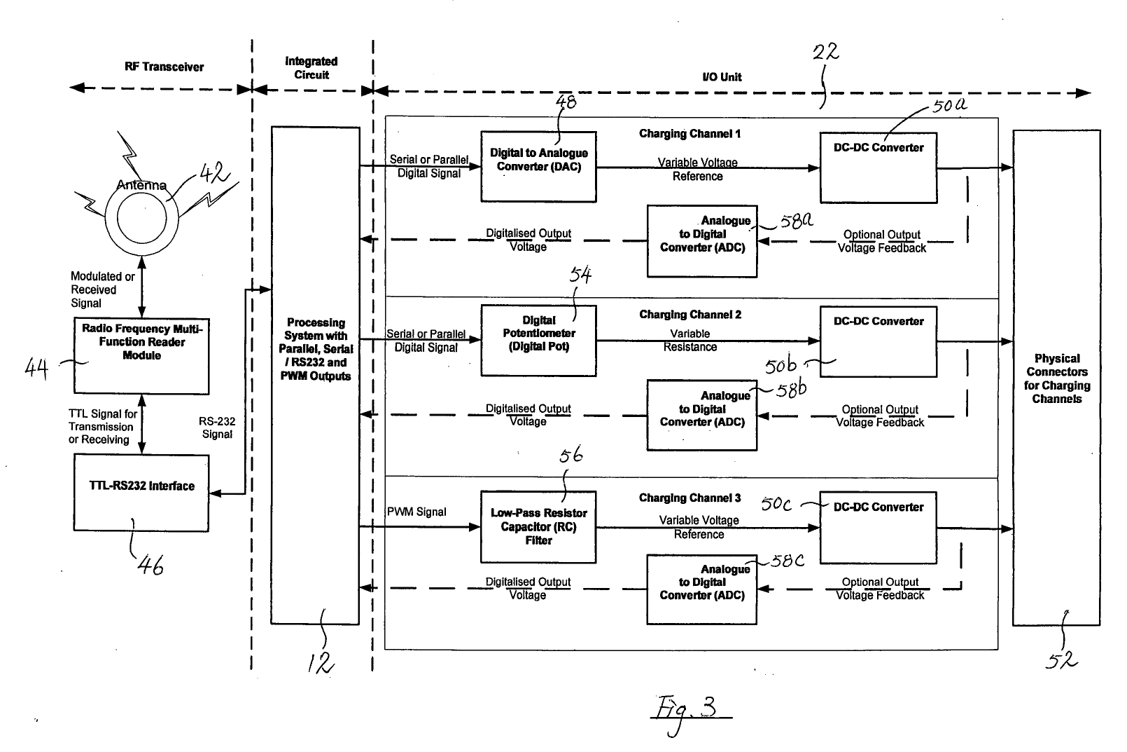

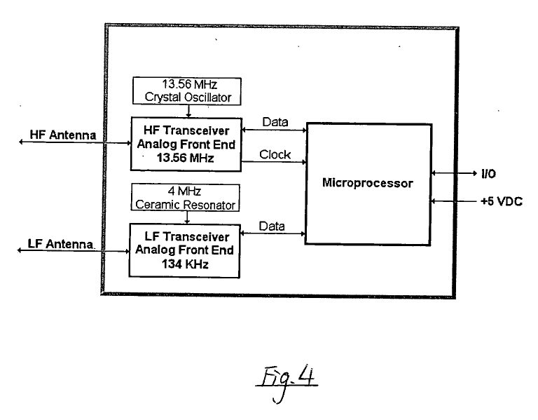

As shown in FIG. 3, the RF transceiver 20 includes an antenna 42 for transmission and reception of RF signals. Modulated or received signals are transmitted between the antenna 42 and a radio frequency multi-function reader module 44. An appropriate radio frequency multi-function reader module may be a multi-function reader module traded by Texas Instruments, of USA, under Serial No. S4100, a block diagram of which being shown in FIG. 4. This multi-function reader module communicates with transponders and vicinity/proximity cards compliant with ISO/IEC 14443 A/B and ISO/IEC 15693.

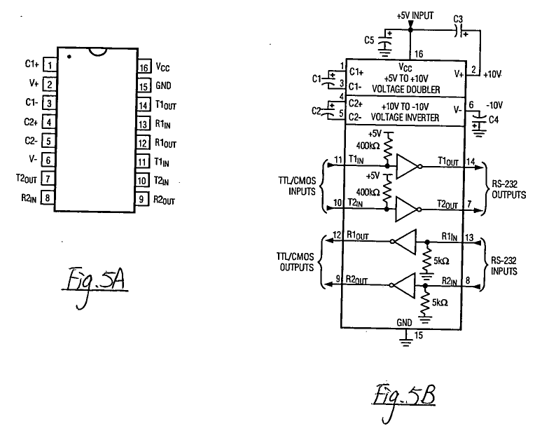

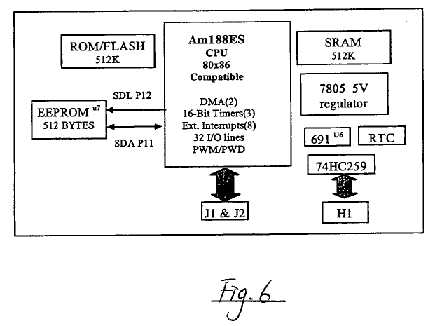

TTL signals for transmission or reception are transmitted between the radio frequency multi-function reader module 44 and a TTL-RS232 Interface 46. An appropriate TTL-RS232 Interface 46 may be a +5V-powered multichannel RS-232 driver/receiver traded by Maxim Integrated Products, of Sunnyvale, Calif., USA, under Model No. MAX232. A top view of such a driver/receiver showing its pin configuration is shown in FIG. 5A and a typical operating circuit of such a driver/receiver is shown in FIG. 5B.

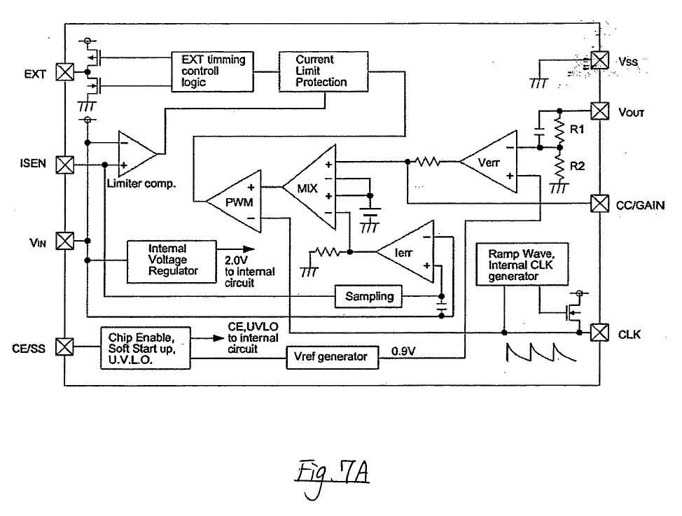

RS-232 signals are transmitted between the TTL-RS232 Interface 46 and the IC 12, which is a processing system with parallel, serial/RS 232 and pulse width modulated (PWM) outputs. An appropriate IC may be a C/C++ programmable, 16-bit microprocessor module with Am188 ES CPU from AMD, traded by Tern Inc., of Davis, Calif., USA, under their trade mark A-Core™, a functional block diagram of which being shown in FIG. 6.

The I/O unit 22 is constructed for varying the voltage of the electric power received from the IC 12 in accordance with the data carried by the RF signals received through the antenna 42, for subsequent transmission to the relevant electric appliances 26a, 26b, 26c. There are at least three ways in which the voltage of the electric power may be digitally varied, each of which being shown in FIG. 3.

In a first way, as shown in charging channel 1 of the I/O unit 22 shown in FIG. 3, serial or parallel digital signals from the IC 12 are transmitted to a digital to analogue converter (DAC) 48, which may be a DAC traded by Dallas Semiconductor, of Dallas, Tex., USA, under Model No. MAX5361. A DAC is a digitally-controlled voltage source. The digital interface to a DAC can be either serial or parallel. Variable voltage reference output is then transmitted to a DC-DC converter 50a.

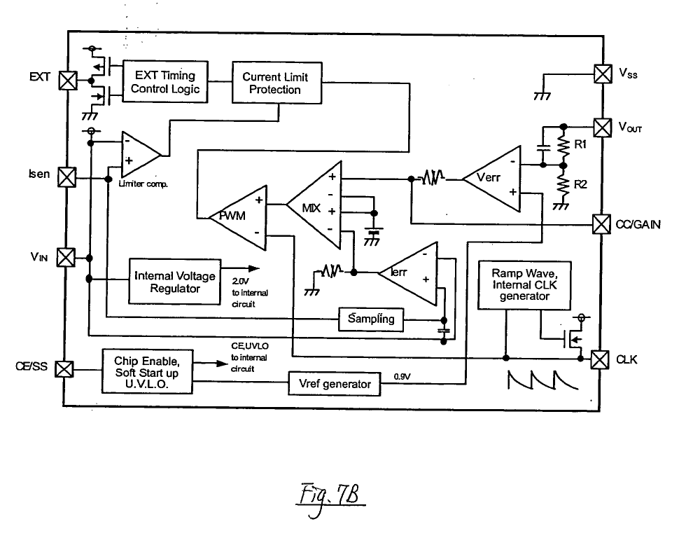

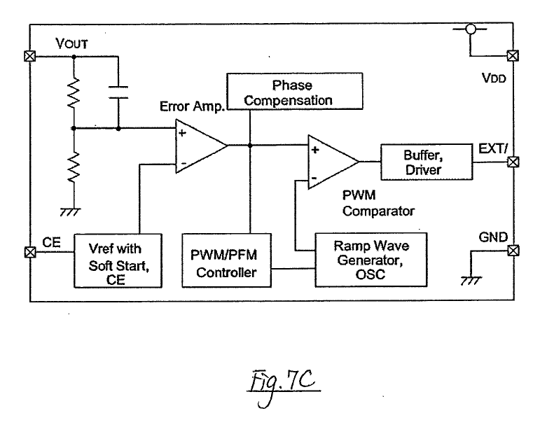

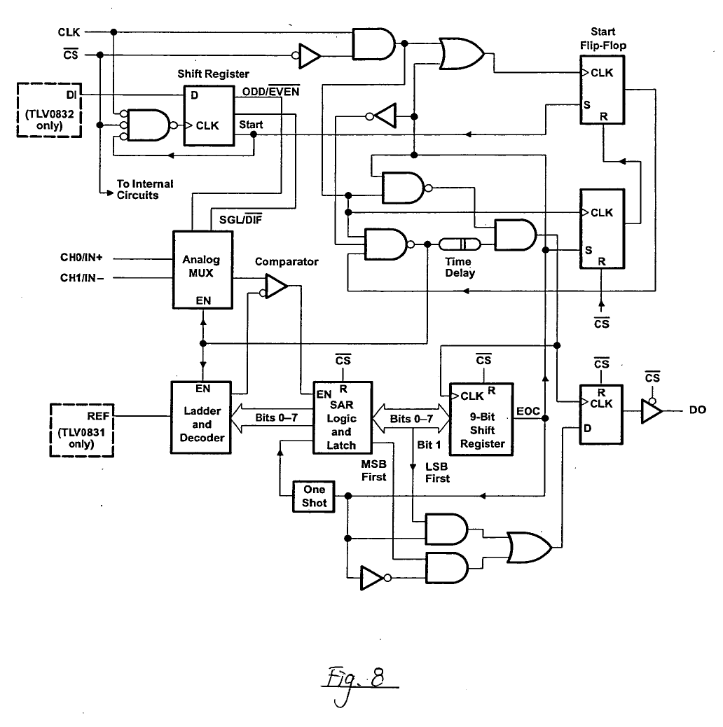

The DC-DC converter 50a may be a step-up DC/DC controller, a step-down DC/DC converter or a step-up & down DC/DC converter controller IC. An appropriate step-up DC/DC controller may be a PWM step-up DC/DC controller traded by Torex Semiconductor Ltd., of Tokyo, Japan under Series No. XC9101, a block diagram of which being shown in FIG. 7A. The XC9101 series are step-up multiple current and voltage feedback DC/DC controller IC's, in which the current sense, clock frequencies and amp feedback gain can all be externally regulated. The input voltage range is from 2.5V to 20V, and the output voltage (V_{OUT}) range is from 2.5V to 16V (and selectable in 100 mV steps) for fixed voltage type, and may be above 30V for adjustment type. The oscillation frequency range is from 100 kHz to 600 kHz.

An appropriate step-down DC/DC converter may be a PWM controlled step-down DC/DC converter traded by Torex Semiconductor Ltd., of Tokyo, Japan, under Series No. XC9201, a block diagram of which being shown in FIG. 7B. With the XC9201 series, a stable power supply is possible with output currents of up to 3.0 A. The input voltage range is from 2.5V to 20V. With the output voltage fixed internally, V_{OUT} is selectable in steps of 100 mV each, within a 1.2V to 16.0V range. The oscillation frequency range is from 100 kHz to 600 kHz.

An appropriate step-up/down DC/DC converter controller IC may be a PWM step-up and down DC/DC converter controller IC traded by Torex Semiconductor Ltd. under Series No. XC9301, a block diagram of which being shown in FIG. 7C. The XC9301 series are built in with fast, low ON resistance drivers. The input voltage range is from 2.0V to 10V and the output voltage is selectable in 100 mV steps within a 2.4V to 6.0V range.

Electric output from the DC-DC converter 50a is fed to a physical connector 52, e.g. an electric contact, for electrical connection with the cable 24a, for connection with and thus powering and/or charging the electric appliance 26a.

In a second way to digitally vary the voltage of the electric power, and as shown in charging channel 2 of the I/O unit 22 shown in FIG. 3, serial or parallel digital signals from the IC 12 are transmitted to a digital potentiometer (digital pot) 54, which may be a digital pot traded by Dallas Semiconductor, of Dallas, Tex., USA, under Model No. MAX5400. A digital potentiometer is a digitally adjustable resistance. The potentiometer resistance typically varies from 0Ω to a maximum value called the “end-to-end resistance”. The MAX5400 is a 256-step potentiometer with a 50 kΩ end-to-end resistance.

Output from the digital potentiometer 54 is fed to a DC-DC converter 50b, which may be a step-up DC/DC controller, a step-down DC/DC converter or a step-up & down DC/DC converter controller IC, examples of which having been provided and discussed above. Electric output from the DC-DC converter 50b is fed to the physical connector 52 for electrical connection with the cable 24b, for connection with and thus powering and/or charging the electric appliance 26b.

In a third way to digitally vary the voltage of the electric power, and as shown in charging channel 3 of the I/O unit 22 shown in FIG. 3, PWM signals from the IC 12 are transmitted to a low-pass resistor capacitor (RC) filter 56. Variable voltage reference from the low-pass RC filter 56 is fed to a DC-DC converter 50c, which may be a step-up DC/DC controller, a step-down DC/DC converter or a step-up & down DC/DC converter controller IC, examples of which having been discussed above. Electric output from the DC-DC converter 50c is fed to the physical connector 52 for electrical connection with the cable 24c, for connection with and thus powering and/or charging the electric appliance 26c.

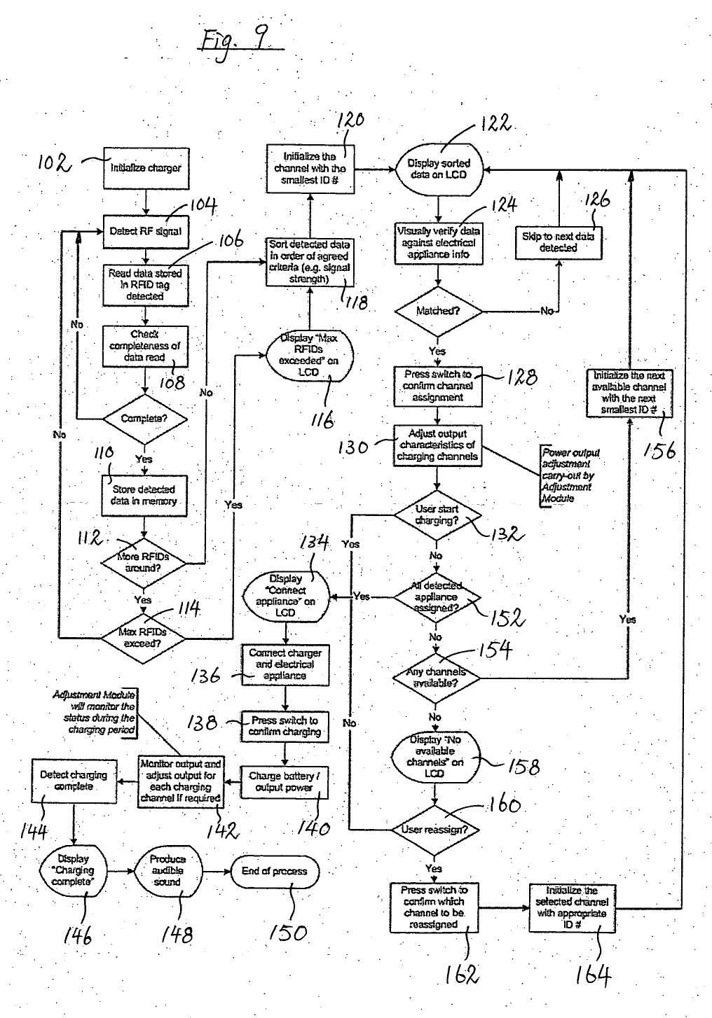

As a preferred optional feature, the voltage of the electric output from the DC-DC converters 50a, 50b, 50c is fed back via a respective analogue to digital converter (ADC) 58a, 58b, 58c to the IC 12 for monitoring purpose. An appropriate ADC may be a 3-volt 8-bit analogue-to-digital converter with serial control, traded by Texas Instruments, of USA, under Series No. TLV0831, a functional block diagram of which being shown in FIG. 8.

The TLV0831 uses a sample-data-comparator structure that converts differential analogue inputs by a successive-approximation routine. The input voltage to be converted is applied to an input terminal and is compared to ground (single ended), or to an adjacent input (differential). The TLV0831 contains only one differential input channel with fixed polarity assignment. The signal can be applied differentially, between IN+ and IN−, to the TLV0831 or can be applied to IN+ with IN− grounded as a single ended input. When the signal input applied to the assigned positive terminal is less than the signal on the negative terminal, the converter output is all zeros.

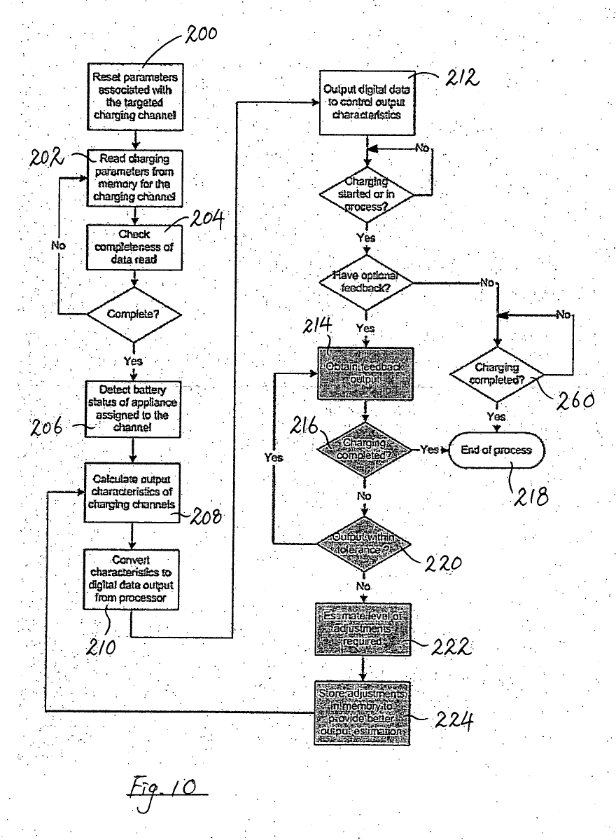

A first mode of operation of the charger 10 is shown in the flow chart in FIG. 9. For the purpose of the following illustration, it is assumed that there are four electric appliances within the operating distance of the charger 10, namely a Brand A laptop computer (EA_{A}) required to be powered at V_{A} volts, a Brand B mobile phone (EA_{B}) with a rechargeable battery, and required to be powered and recharged at V_{B} volts, a Brand C PDA (EA_{C}) required to be powered at V_{C} volts, and a Brand D digital camera (EA_{D}) with a rechargeable battery rechargeable at V_{D} volts. Each of the four electric appliances is attached with a respective RFID tag, in which is electronically stored and/or on which is visually indicated information relating to the charging/powering parameters of the relevant appliance or the rechargeable battery in the appliance.

Referring now to FIG. 9, a charger 10 may be initialized 102 by activation of a switch by a user. The charger 10 will then transmit RF signals according to its operating range and detect 104 RF signals from RFIDs within the operating distance. The charger 10 will then read 106 data representing information stored in the detected RFIDs, and check 108 completeness of the data read. If the data are not complete, it will resume detection 104 of RF signals. If, on the other hand, the read data are complete, the data will be stored 110 in the memory module 38 of the IC 12. The charger 10 will keep on checking 112 if there are more RFIDs around. If so, it will then check 114 if the maximum number of RFIDs allowed has been exceeded. For example, in the present example, after detection of the first RFID, the charger 10 will keep on detection of the second RFID, and the third RFID. Although the charger 10 as shown in FIG. 1 has only three charging channels, each represented by a respective cable 24a, 24b and 24c, the maximum number of RFIDs allowed may be more than three, subject to the setting of the user and/or factory setting. If, for example, the maximum number of RFIDs allowed is five, the charger 10 can detect and display the existence of up to five RFID-bearing electric appliances within its operating range. Upon detection of the sixth RFID, the message “Max RFIDs exceeded” will be displayed 116 on the LCD, forming part of the display unit 16.

Of course, as in the above example, as the charger only has three charging channels, although a total of five electric appliances may have been detected, it can only charge/power up to three electric appliances at any given point of time. To decide which of the detected electric appliances are to be connected to the charger 10 for powering/charging, the detected data will be sorted 118 in order of agreed criteria, e.g. in descending order of strength of the RF signals detected. The charging channels from the smallest identification number onward will then be initialized 120. The sorted data will then be displayed 122 on the LCD, e.g. as in the following Table 1:

TABLE 1

Detected Electric Appliance 1: Brand A laptop computer (EA_{A})
Detected Electric Appliance 2: Brand B mobile phone (EA_{B})
Detected Electric Appliance 3: Brand C PDA (EA_{C})
Detected Electric Appliance 4: Brand D digital camera (EA_{D})
Detected Electric Appliance 5: Brand E mobile phone (EA_{E})

Such allows the user to visually verify 124 the displayed data against the information of the electrical appliances. If the displayed data do not match the information of the electrical appliances, it will skip 126 to the next data detected, and displayed again 122 on the LCD. On the other hand, if the displayed data match the information of the electrical appliances, the user may effect the channel assignment by pressing 128 a switch, e.g. as in the following Table 2.

TABLE 2

Charging Channel 1: Brand A laptop computer (EA_{A})
Charging Channel 2: Brand B mobile phone (EA_{B})
Charging Channel 3: Brand C PDA (EA_{C})

The charger 10 will then adjust 130 the output characteristics of the charging channels accordingly, further details of which will be discussed below.

If the user confirms that charging is to start 132, a message “Connect appliance” will be displayed 134 on the LCD, which prompts the user to physically connect 136 the charger 10 with the relevant electric appliances, e.g. in accordance with Table 2 above, and to press 138 a switch to confirm charging. The charger 10 will transmit, in accordance with the data in the RF signals received, electric power of V_{A} volts via Charging Channel 1, electric power of V_{B} volts via Charging Channel 2, and electric power of V_{C} volts via Charging Channel 3, for charging and/or powering 140 EA_{A}, EA_{B}, and EA_{C} respectively. The output of each of the Charging Channels 1, 2 and 3 may be monitored 142 and, if necessary, adjusted. When, upon detection 144, charging is complete, the message “Charging complete” will be displayed 146, and an audible sound produced 148 for notifying the user. The whole process will also end 150. It is of course possible that the charging/powering process for the respective electric appliance connected with the charger 10 may complete at different time.

If the user does not confirm that charging is to start, the charger 10 will check 152 whether all detected appliances have been assigned a respective charging channel. If so, the charger will also display 134 a message “Connect appliance” on the LCD, prompting the user to continue with the charging/powering procedure.

If, on the other hand, not all the appliances have been assigned a respective charging channel, the charger 10 will check 154 whether any channels are still available. If so, the charger 10 will initialize 156 the next available channel with the next smallest identification number. The revised sorted data will again be displayed 122 on the LCD. If, on the other hand, no more charging channels are available, the message “No available channels” will be displayed 158 on the LCD.

The user will be allowed the opportunity to decide 160 whether to re-assign the charging channels. If the user does not re-assign the charging channels, the charger will display 134 a message “Connect appliance” on the LCD, prompting the user to continue with the charging/powering procedure. On the other hand, if the user decides to re-assign the charging channels, he/she has to press 162 a switch to confirm the channel to be re-assigned. This allows the user to, say, remove the assignment of EA_{C} from Charging Channel 3, and re-assign EA_{D} in its stead. The selected channel will be initialized 164 with an appropriate identification number. The revised sorted data will again be displayed 122 on the LCD, to be visually verified 124 by the user.

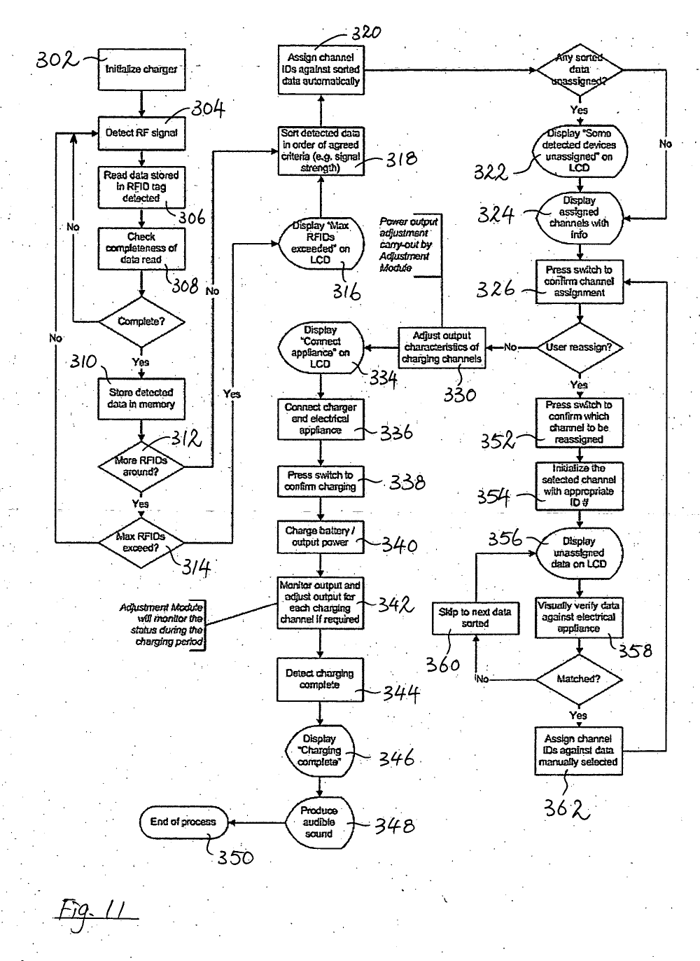

Referring to the adjustment process 130 and monitoring process 142, such is shown in more detail in the flow chart in FIG. 10. In this flow chart, boxes in shade are optional steps in connection with acquiring feedback on the charger's output as a means for refining charging characteristics of a charging channel. For this purpose, the parameters associated with the relevant charging channels will be reset 200. The charger 10 will then read 202 the charging parameters for the charging channels from the memory module 38 of the IC 12. It will then check 204 if the read data are complete. If not, it will read 202 the parameters again. If the read data are found to be complete, the charger 10 will detect 206 the battery status of the appliance assigned to the respective channel.

The charger 10 will also calculate 208 the output characteristics of the charging channels, and convert 210 the characteristics to digital data output from the central processing module 30 of the IC 12. Digital data will then be outputted 212 to control output characteristics. If the charging has been started or in progress, and if the optional feedback mechanism is available and activated, feedback on the output characteristics of the charging channels are obtained 214, e.g. via the ADC 58a, 58b, 58c discussed above. If the charging process is completed 216, the process will end 218. If not, the charger 10 will monitor if the output is within a preset tolerance 220. If so, feedback on the output characteristics of the charging channels will be continuously obtained 214 for monitoring purpose. If, on the other hand, the output is beyond a preset tolerance 220, the central processing module 30 of the IC 12 will estimate 222 the level of adjustments required, which will be stored 224 in the memory module 38 to provide better output estimation. Such will also be used for calculation 208 of the characteristics of the charging channels for charging the respective appliances. On the other hand, if there is no optional feedback mechanism available or if such is not activated, the charger 10 will keep on monitoring if the charging/powering process is complete 260, and will end the operation 218 when the charging/powering process is complete. Again, it is of course possible that the charging/powering process for the respective electric appliance connected with the charger 10 may complete at different time.

FIG. 11 shows a flow chart depicting an alternative mode of operation of the charger 10. The charger 10 may be initialized 302 by activation of a switch by a user. The charger 10 will then transmit RF signals according to its operating range and detect 304 RF signals from RFIDs within its range of operation. The charger 10 will then read 306 data representing information stored in the detected RFIDs, and check 308 completeness of the data read. If the data are not complete, it will resume detection 304 of RF signals. If, on the other hand, the read data are complete, the data will be stored 310 in the memory module 38 of the IC 12. The charger 10 will keep on checking 312 if there are more RFIDs around. If so, it will then check 314 if the maximum number of RFIDs allowed has been exceeded. For example, in the present example, after detection of the first RFID, the charger 10 will keep on detection of the second RFID, and the third RFID. Although the charger 10 as shown in FIG. 1 has only three charging channels, each represented by a respective cable 24a, 24b and 24c, the maximum number of RFIDs allowed may be more than three, depending on the user's setting or the factory setting. If, e.g. the maximum number of RFIDs allowed to be detected is five, upon detection of the sixth RFID, the message “Max RFIDs exceeded” will be displayed 316 on the LCD, forming part of the display unit 16.

The detected data will be sorted 318 in order of agreed criteria, e.g. in descending order of strength of the RF signals detected. The charger 10 will then assign 320 IDs against the sorted data automatically. If there are still sorted data unassigned, a message “Some detected devices unassigned” will be displayed 322 on the LCD, and the assigned channels with information will also be displayed 324 on the LCD. If there are no sorted data unassigned, only the assigned channels with information will be displayed 324 on the LCD.

The user is then required to press 326 a switch to confirm channel assignment. The user will be given the chance of re-assigning the channels. If no re-assignment is to be effected, The charger 10 will then adjust 330 the output characteristics of the charging channels, in the manner discussed above and in conjunction with FIG. 10.

A message “Connect appliance” will then be displayed 334 on the LCD, which prompts the user to physically connect 336 the charger 10 with the relevant electric appliances accordingly, and to press 338 a switch to confirm charging. The charger 10 will transmit, in accordance with the data in the RF signals received, electric power of V_{A} volts via Charging Channel 1, electric power of V_{B} volts via Charging Channel 2, and electric power of V_{C} volts via Charging Channel 3, for charging and/or powering 340 EA_{A}, EA_{B}, and EA_{C} respectively. The output of each of the Charging Channels 1, 2 and 3 may be monitored 342 and, if necessary, adjusted. When, upon detection 344, charging is complete, the message “Charging complete” will be displayed 346, and an audible sound produced 348 for notifying the user. The whole process will also end 350. Again, the charging/powering process for different electric appliances connected with the charger 10 may end at different time.

If the user instead decides to re-assign the charging channels, he/she can press 352 a switch to confirm the channel to be re-assigned. The selected channel will then be initialized 354 with an appropriate ID number. The unassigned data will be displayed 356 on the LCD. The user is then to visually verify 358 the data against the desired electrical appliance. If they do not match, the charger 10 will skip 360 to the next sorted data for display 356. If the data match the desired electrical appliance, the channel IDs will be assigned 362 against the data manually selected, and the user is required to press a switch 326 to confirm the channel assignment.

It should be understood that the above only illustrates an example whereby the present invention may be carried out, and that various modifications and/or alterations may be made thereto without departing from the spirit of the invention.

It should be understood that although the present embodiment utilizes the RFID technology, it is only one of the possible technologies for working the present invention. In particular, it is envisaged that the relevant data can be obtained in other contactless manner, e.g. by an infra-red emitter-reader, or to be encoded in a bar code to be read by a bar-code reader.

Similarly, although the present invention has thus far be described in the context of varying the voltage of the electric power transmitted to the electric appliances for powering and/or charging the appliances, it should be understood that other charging and/or powering parameters, such as current, cycle, and charging algorithm, may also be varied.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

What is claimed is:

1. An electric accessory adapted to be connected with at least one electric appliance for providing electric power to said appliance, said accessory including:
means adapted to contactlessly receive data representing at least one charging and/or powering parameter of said at least one appliance;
transforming means adapted to be electrically connected with an electric power source for receiving electric power therefrom, and adapted to be electrically connected with said appliance for transmitting electric power thereto;
wherein said transforming means is adapted to vary, in accordance with said received data, at least one parameter of the electric power received from said electric power source for subsequent transmission to said appliance.

2. An accessory according to claim 1 wherein said data receiving means includes a radio frequency (RF) transceiver, an infra-red signal emitter-reader or a bar-code reader.

3. An accessory according to claim 1 wherein said data receiving means is adapted to transmit radio frequency signals or infra-red signals to the outside environment.

4. An accessory according to claim 1 wherein said transforming means is adapted to vary, in accordance with said received data, at least the voltage of the electric power received from said electric power source for subsequent transmission to said appliance.

5. An accessory according to claim 1 wherein said transforming means is adapted to be electrically connected with at least two electric appliances for simultaneous transmission of electric power to said at least two electric appliances.

6. An accessory according to claim 5 wherein said transforming means is adapted to be electrically connected with at least two electric appliances each with a different set of charging and/or powering parameters for simultaneous transmission of electric power to said at least two electric appliances.

7. An accessory according to claim 1 wherein said transforming means is adapted to transmit electric power via at least first and second output channels, wherein the electric power transmitted via said first output channel and the electric power transmitted via said second output channel differ at least in one parameter.

8. An accessory according to claim 7 wherein the electric power transmitted via said first output channel and the electric power transmitted via said second output channel differ at least in voltage.

9. An accessory according to claim 1 wherein said data receiving means is adapted to contactlessly receive data representing at least one charging and/or powering parameter of a plurality of electric appliances.

10. An accessory according to claim 5 further including means for assigning a channel for transmitting electric power to each of said at least two electric appliances.

11. An accessory according to claim 10 further including means for re-assigning the channels assigned to said at least two electric appliances.

12. An accessory according to claim 1 further including means for detecting at least one parameter of the electric power transmitted to said at least one electric appliance.

13. An accessory according to claim 12 wherein said detecting means is adapted to detect at least the voltage of the electric power transmitted to said at least one electric appliance.

14. An accessory according to claim 12 further including means for varying, with reference to the detected parameter, at least one parameter of the electric power provided to said at least one electric appliance.

15. An accessory according to claim 14 wherein said varying means is adapted to vary, with reference to the detected parameter, at least the voltage of the electric power transmitted to said at least one electric appliance.

16. A method of providing electric power to at least one electric appliance, including the steps of:
(a) contactlessly receiving data representing at least one charging and/or powering parameter of said at least one appliance;
(b) receiving electric power from an electric power source;
(c) varying, in accordance with said received data, at least one parameter of the received electric power; and
(d) transmitting the varied electric power to said at least one appliance.

17. A method according to claim 16 further including a step (e) of inputting said data into a radio frequency identification (RFID) tag.

18. A method according to claim 17 further including a step (f) of associating said RFID tag with said at least one electric appliance.

19. A method according to claim 18 wherein said step (f) is carried out by attaching said RFID tag to said at least one electric appliance.

20. A method according to claim 16 wherein in said step (a), said data are received by a radio frequency (RF) transceiver, an infra-red signal emitter-reader or a bar-code reader.

21. A method according to claim 16 wherein in said step (c), at least the voltage of the electric power received from said electric power source is varied in accordance with said received data for subsequent transmission to said at least one electric appliance.

22. A method according to claim 16 wherein in said step (d), said varied electric power is transmitted to at least two electric appliances.

23. A method according to claim 16 wherein in said step (d), said varied electric power is transmitted to at least two electric appliances each with a different set of charging and/or powering parameters for simultaneous provision of electric power to said at least two electric appliances.

24. A method according to claim 23, wherein in said step (d), electric power is transmitted via at least first and second output channels, each electrically connected with one of said at least two electric appliances, wherein the electric power transmitted via said first output channel and the electric power transmitted via said second output channel differ at least in one parameter.

25. A method according to claim 24 wherein the electric power transmitted via said first output channel and the electric power transmitted via said second output channel differ at least in voltage.

26. A method according to claim 16 wherein in said step (a), data representing at least one charging and/or powering parameter of a plurality of electric appliances are contactlessly received.

27. A method according to claim 22 further including a step (g) of assigning a channel for transmitting electric power to each of said at least two electric appliances.

28. A method according to claim 27 further including a step (h) of re-assigning the channels assigned to said at least two electric appliances.

29. A method according to claim 16 further including a step (i) of detecting at least one parameter of the electric power transmitted to said at least one electric appliance.

30. A method according to claim 29 wherein in said step (i), at least the voltage of the electric power transmitted to said at least one electric appliance is detected.

31. A method according to claim 29 further including a step (j) of varying, with reference to the detected parameter, at least one parameter of the electric power transmitted to said at least one electric appliance.

32. A method according to claim 31 wherein in said step (j), at least the voltage of the electric power transmitted to said at least one electric appliance is varied with reference to the detected parameter.
